(19) United States
(12) Patent Application Publication
(10) Pub. No.: US 2014/0228492 A1
(43) Pub. Date: Aug. 14, 2014

(54) POLYAMIDE RESIN COMPOSITION FOR WHEEL COVER

(71) Applicants: Hyundai Motor Company, Seoul (KR); Ecoplastic Corporation, Gyeongju (KR); Kolon Plastics, Inc., Gimcheon (KR)

(72) Inventors: Duck-Hyoung Hwang, Seoul (KR); Yong-Chul Lee, Gyeongju (KR); Sung-Woo Lee, Gyeongju (KR); Chang-Gyu Kim, Gumi (KR); Ji-Hyuk Park, Daegu (KR)

(21) Appl. No.: 13/936,516

(22) Filed: Jul. 8, 2013

(30) Foreign Application Priority Data
Feb. 13, 2013 (KR) 10-2013-0015169

(51) Int. Cl. C09D 177/02

(52) U.S. Cl. CPC C09D 177/02
USPC 524/222; 524/504; 524/445

(57) ABSTRACT

Disclosed is a polyamide resin composition for a wheel cover, which has an excellent balance between rigidity and toughness, improved low temperature impact property, excellent heat resistance, and improved strength of the surface of the composition and the weld. In particular, the polyamide resin composition comprises a polyamide 6 resin, an ethylene-based copolymer, a styrene-based copolymer, a maleic anhydride grafted styrene, an imide-based copolymer, nano-minerals, and a phenolic heat-resistant material.

### CROSS-REFERENCE TO RELATED APPLICATIONS

This application claims priority under 35 U.S.C. §119 to Korean Patent Application No. 10-2013-0015169, filed on Feb. 13, 2013, in the Korean Intellectual Property Office, the disclosure of which is incorporated herein by reference in its entirety.

### BACKGROUND OF THE INVENTION

1. Field of the Invention

The present invention relates to a polyamide resin composition for a wheel cover, and more particularly, to a polyamide resin composition that provides excellent balance between rigidity and toughness, improved low temperature impact property, and excellent heat resistance. In particular, the present polyamide resin composition includes a polyamide 6 resin, an ethylene-based copolymer, a styrene-based copolymer, a maleic anhydride grafted styrene, an imide-based copolymer, nano-minerals, and a phenolic heat-resistant material.

2. Description of the Related Art

Polyamide was developed by DuPont in 1939, and is currently a product which is produced in the largest amount among five major engineering plastics. At least half of the polyamide production is polyamide 6 and polyamide 66, with the production amount of polyamide 6 being greater.

Since polyamide has excellent mechanical strength, heat resistance, abrasion resistance, chemical resistance, flame retardancy, processability and the like, at least 600 types of polyamide-improved products have been developed through copolymerization and combination with other materials.

Polyamide has been applied to a wide variety of fields, such as automobile parts, electric and electronic parts, mechanical parts, construction material parts, medical goods, household goods and the like due to its excellent physical properties. In the automobile field, the demand for polyamide has continued to increase each year, and in particular, the demand for nylon 66 has increased greatly due to its excellent physical properties.

The numbers 6 and 66 in polyamide 6 and polyamide 66 are names given for the molecular structures thereof, and are frequently referred to as nylon resin. Nylon 66 was developed by DuPont Company in the United States, and nylon 6 (commonly referred to as Amilan) was developed by International Technology Corp. in Japan.

Polyamide 6 and 66 resins have often been used as materials for a vehicle due to their rigidity, toughness, and heat resistance, which are characteristics of the amide bond. In particular, polyamide 66 has excellent heat resistance compared to polyamide 6, and thus is frequently used in parts requiring heat-resistance and in environmentally-friendly parts such as a cylinder head cover, a radiator head tank, an oil fan and the like of a vehicle. As a wheel cover for a vehicle, a polyamide 66 material which has excellent heat resistance has been used due to heat generated at the wheel cover area during driving and braking of the vehicle.

However, in the case of a vehicle wheel cover, mechanical strength, impact resistance and the like, as well as heat resistance, are required. Thus efforts have been made to replace the vehicle wheel cover with one made of polyamide 6, which has better mechanical strength and impact resistance than polyamide 66. However, it is difficult to obtain a proper balance between rigidity and toughness of polyamide 6. Further, the level of physical properties required in a vehicle wheel cover fails to be satisfied using polyamide 6 due to an associated reduction in heat resistance caused by the use of additives for improving rigidity and the like.

### SUMMARY OF THE INVENTION

The present invention provides a polyamide resin composition for a wheel cover, which has an excellent balance between rigidity and toughness, improved low temperature impact property, and excellent heat resistance. More particularly, the present invention provides a polyamide resin composition comprising a polyamide 6 resin, an ethylene-based copolymer, a styrene-based copolymer, a maleic anhydride grafted styrene, an imide-based copolymer, nano-minerals, and a phenolic heat-resistant material.

According to one aspect, the present invention provides a polyamide resin composition for a wheel cover, including a polyamide 6 resin, an ethylene-based copolymer, a styrene-based copolymer, a maleic anhydride grafted styrene, an imide-based copolymer, nano-minerals, and a phenolic heat-resistant material.

According to various embodiments, the polyamide 6 resin composition comprises about 10 to 25 parts by weight of the ethylene-based copolymer, about 10 to 25 parts by weight of the styrene-based copolymer, about 2 to 5 parts by weight of the maleic anhydride grafted styrene, about 5 to 10 parts by weight of the imide-based copolymer, about 2 to 5 parts by weight of nano minerals, and about 0.5 to 2 parts by weight of the phenolic heat-resistant material based on 100 parts by weight of the polyamide 6 resin composition.

According to various embodiments, the polyamide 6 resin has a relative viscosity of about 2.7 to 3.5.

The ethylene-based copolymer can be any conventional ethylene-based copolymer and, preferably is a random block copolymer of ethylene and octene, in which maleic anhydride is grafted.

According to various embodiments, styrene in the styrene-based copolymer is present in an amount of about 80 to 90 parts by weight based on 100 parts by weight of the copolymer.

According to various embodiments, grafted maleic anhydride in the maleic anhydride grafted styrene is present in an amount of about 5 to 15 parts by weight based on 100 parts by weight of the styrene.

According to various embodiments, the imide-based copolymer is a polyamide imide in which amide and imide are bonded to each other.

The nano minerals may be any conventional nano minerals, and preferably is a clay having an average particle size from about 1 to 100 nm.

The heat-resistant material may be any conventional heat-resistant material used in vehicle parts such as a wheel cover, and preferably is N,N′-hexamethylenebis(3,5-di-tert-butyl-4-hydroxyhydrocinnamide).

According to the present invention, a separate additional process is not needed in order to improve scratch resistance and low glossiness of the composition. As such, that the present invention can provide cost reduction and improved productivity.

Further, according to the present invention there is an advantage in that balance between rigidity and toughness is excellent, low temperature impact property is improved, and heat resistance is excellent, as compared to a conventional polyamide 6 wheel cover material.

In addition, the present invention has an effect of satisfying the requirements for a wheel cover for a vehicle, obtaining excellent moldability, and improving the strength of the surface and weld of the wheel cover.

Other aspects and exemplary embodiments of the invention are discussed infra.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view of a conventional vehicle wheel cover.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Terms or words used in the present specification and claims should not be interpreted as being limited to typical or dictionary meanings, but should be interpreted as having meanings and concepts, which comply with the technical spirit of the present invention, based on the principle that an inventor can appropriately define the concept of the term to describe his/her own invention in the best manner.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be described in detail with reference to Tables and drawings.

The present invention relates to a polyamide resin composition for a wheel cover.

According to a preferred embodiment, the present invention provides a polyamide resin composition that includes a polyamide 6 resin, an ethylene-based copolymer, a styrene-based copolymer, a maleic anhydride grafted styrene, an imide-based copolymer, nano minerals, a phenolic heat-resistant material, and the like. Hereinafter, the constituent components and contents of the present invention will be investigated in detail.

### (1) Polyamide 6 Resin

A polyamide resin, also generally referred to as nylon, is an engineering plastic having excellent strength, chemical resistance, processability, and the like. Examples of polyamides include polyamide 6, polyamide 66, polyamide 610, polyamide 612, polyamide 11, and the like. In particular, it is preferred that the polyamide 6 resin of the present invention is obtained through a ring-opening polymerization, which is a reaction in which ε-caprolactam is polymerized while a ring-shaped compound undergoes a ring opening.

Furthermore, it is preferred that the polyamide 6 resin of the present invention has a relative viscosity of about 2.7 to 3.5 (a solution of 1 g of the polyamide 6 resin in 100 ml of 96% sulfuric acid at 20° C.).

When the relative viscosity of the polyamide 6 resin is less than about 2.7, the rigidity, impact strength, and heat resistance of the composition may be reduced. On the other hand, when the relative viscosity is more than about 3.5, the fluidity of the composition may be reduced to make the surface of the composition defective.

### (2) Ethylene-Based Copolymer

The ethylene-based copolymer contributes to improving the low temperature impact property of the composition. The ethylene-based copolymer can be selected from such conventional copolymers, and is preferably a random block copolymer of ethylene and octene, in which the maleic anhydride is grafted. More specifically, it is preferred that the maleic anhydride grafted to ethylene is present in an amount of about 0.5 to 6.0 parts by weight based on 100 parts by weight of ethylene. When the content of the maleic anhydride grafted to ethylene is less than about 0.5 part by weight, the low temperature impact property of the composition is insufficient, and when the content thereof is more than about 6.0 parts by weight, physical properties, such as the tensile strength, of the composition may be reduced.

Further, it is preferred that the ethylene-based copolymer is present in an amount of about 10 to 25 parts by weight based on 100 parts by weight of the polyamide 6 resin. When the content of the ethylene-based copolymer is less than about 10 parts by weight, the low temperature impact property of the composition is insufficient. On the other hand, when the content thereof is more than about 25 parts by weight, the composition has excellent low temperature impact property characteristics, but the tensile strength, flexural strength, flexural modulus, and heat deflection temperature are reduced, making the composition inadequate for use as a wheel cover.

### (3) Styrene-Based Copolymer

The styrene-based copolymer contributes to improved heat resistance, dimensional stability and paintability of the composition and the strength of the weld. It is preferred that styrene is present in an amount of about 80 to 90 parts by weight based on 100 parts by weight of the copolymer. When the content of styrene is less than about 80 parts by weight, it is difficult to sufficiently improve heat resistance, dimensional stability and the like of the composition. On the other hand, when the content thereof is more than about 90 parts by weight, the tensile strength of the composition may decrease.

Further, it is preferred that the styrene-based copolymer is present in an amount of about 10 to 25 parts by weight based on 100 parts by weight of the polyamide 6 resin. When the content of the styrene-based copolymer is less than about 10 parts by weight, the central part of the composition to be injected sags compared to the original shape and the paintability thereof becomes poor. On the other hand, when the content is more than about 25 parts by weight, the central part of the composition to be injected is swollen compared to the original shape and the tensile strength, flexural strength and low temperature impact property thereof may be reduced to a level below those required.

### (4) Maleic Anhydride Grafted Styrene

The maleic anhydride grafted styrene is a styrene in which the maleic anhydride is grafted. This material provides compatibility between the styrene-based copolymer and the polyamide 6 resin.

It is preferred that grafted maleic anhydride in the maleic anhydride grafted styrene is present in an amount of about 5 to 15 parts by weight based on 100 parts by weight of the styrene. When the content of the maleic anhydride is less than about 5 parts by weight, the compatibility is insufficient, and when the content thereof is more than about 15 parts by weight, the beneficial effect of adding further maleic anhydride becomes small compared to the cost.

In addition, it is preferred that the maleic anhydride grafted styrene is present in an amount of about 2 to 5 parts by weight based on 100 parts by weight of the polyamide 6 resin. When the content of the maleic anhydride grafted styrene is less than about 2 parts by weight, the compatibility of the styrene-based copolymer with the polyamide 6 is reduced, thereby reducing the tensile strength, flexural strength, flexural modulus, impact strength and the like to a level less than that required. On the other hand, when the content thereof is more than about 5 parts by weight, the fluidity of the composition is so low that moldability deteriorates and the surface of the composition may become poor.

### (5) Imide-Based Copolymer

The imide-based copolymer contributes to increasing the heat deflection temperature of the composition. While any conventional imide-based copolymers can be used, it is preferred to use a polyamide-imide in which amide and imide are included. Furthermore, since it is costly to increase the temperature to the required heat deflection temperature using only the polyamide-imide and since it is important to prevent deterioration in the low temperature impact property of the composition, it is preferred that the polyamide-imide is used together with nano minerals.

It is preferred that the imide-based copolymer is present in an amount of about 5 to 10 parts by weight based on 100 parts by weight of the polyamide 6 resin. When the content of the imide-based copolymer is less than about 5 parts by weight, an effect of improving the heat deflection temperature of the composition is not sufficient. On the other hand, when the content thereof is more than about 10 parts by weight, the effect of improving the heat deflection temperature by adding further imide-based copolymer is small in comparison to the amount of imide-based copolymer added, thereby decreasing the economic efficiency and reducing the low temperature impact property of the composition to a level less than that required.

### (6) Nano Minerals

The nano minerals are preferably added together with the imide-based copolymer in order to improve the heat deflection temperature of the composition without reducing the low temperature impact property of the composition. The nano minerals contribute to improving the flexural modulus of the composition, which may be reduced by various additives.

The nano minerals refer to nano-sized minerals, and in particular, it is preferred that the nano minerals are a clay having an average particle size from about 1 to 100 nm. When the average particle size of the clay is less than about 1 nm, the heat deflection temperature of the composition is insufficiently improved, and when the size thereof is more than about 100 nm, an effect of increasing the heat deflection temperature of the composition may not be sufficient.

In addition, it is preferred that the nano minerals are present in an amount of about 2 to 5 parts by weight based on 100 parts by weight of the polyamide 6 resin. At this time, when the content thereof is less than about 2 parts by weight, an effect of increasing the flexural modulus and heat deflection temperature of the composition may not be sufficient. On the other hand, when the content thereof is more than about 5 parts by weight, an effect of increasing the flexural modulus and heat deflection temperature of the composition is small in comparison to the additional amount of nano minerals added, thereby decreasing the economic efficiency and making the surface of the composition rough.

### (7) Phenolic Heat-Resistant Material

The heat-resistant material not only improves the durability of the composition by enhancing the stability of the composition to heat, but also serves to prevent the discoloration of the composition, which may occur during the processing and molding.

The heat-resistant material of the present invention can be any conventional heat resistant material, and is preferably a phenolic heat-resistant material, more preferably N,N′-hexamethylenebis(3,5-di-tert-butyl-4-hydroxyhydrocinnamide).

It is preferred that the phenolic heat-resistant material is present in an amount of about 0.5 to 2 parts by weight based on 100 parts by weight of the polyamide 6 resin. When the content of the phenolic heat-resistant material is less than about 0.5 part by weight, a heat resistant-effect of the composition may not be sufficient. On the other hand, when the content thereof is more than about 2.0 parts by weight, the heat resistant-effect is small compared to the additional amount, and thus the economic efficiency deteriorates and the surface of the composition may become poor.

### (8) Use

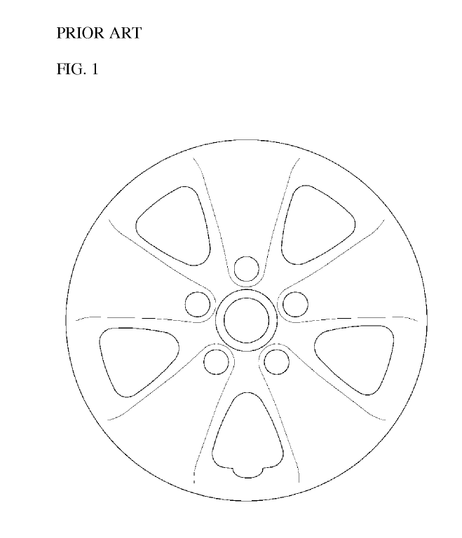

FIG. 1 is a front view of a vehicle wheel cover. It is preferred that the polyamide resin composition for a wheel cover according to the present invention is applied to a wheel cover for a vehicle, such as the wheel cover depicted in FIG. 1.

### (9) Preparation Method

Hereinafter, a method for preparing a polyamide resin composition for a wheel cover will be described from another viewpoint.

The polyamide resin composition for a wheel cover of the present invention may be appropriately prepared by those skilled in the art with reference to known technologies. More specifically, it is preferred that each constituent component of the present invention is placed into a mixer and mixed, then melt-kneaded by using an extruder and dried by a dryer, and then the polyamide resin composition of the present invention is prepared through an extruder.

The extruder may be any conventional extruder, and is preferably a twin screw extruder. The operating conditions may suitably be determined, and preferably the extrusion is carried out at a suitable heightened temperature of the composition such as is about 250° C. to 260° C.

Furthermore, in order to maximize the effective kneading of the resin composition and the dispersibility of the nano minerals, it is preferred that at least two reverse elements are arranged in the screw arrangement of the extruder.

Moreover, it is preferred that the residence time in the extruder is minimized in order to prevent the thermal decomposition of the composition during the melt-kneading. Further, it is preferred that the screw rotation speed of the extruder is preferably about 250 rpm or more in order to maximize the low temperature impact property in the present composition.

Hereinafter, the present invention will be described in more detail through Examples. These Examples are only for illustrating the present invention, and it will be obvious to those skilled in the art that the scope of the present invention is not interpreted to be limited by these Examples.

### EXAMPLE

Specimens of the polyamide resin composition for a wheel cover according to the present invention in the Examples and Comparative Examples were prepared with reference to the constituent components and contents of the following Table 1 (wherein amounts are parts by weight relative to 100 parts by weight of polyamide 6), and then physical properties were compared and summarized in the following Table 2.

TABLE 1

| | | Ethylene- | | Maleic | | | |
|---|---|---|---|---|---|---|---|
| | | based | Styrene-based | anhydride | Imide-based | | Phenolic heat- |
| Classification | Polyamide 6 | copolymer | copolymer | grafted styrene | copolymer | Nano minerals | resistant material |
| Example 1 | 100 | 17 | 17 | 3 | 8 | 3 | 1 |
| Example 2 | 100 | 10 | 17 | 3 | 8 | 3 | 1 |
| Example 3 | 100 | 25 | 17 | 3 | 8 | 3 | 1 |
| Example 4 | 100 | 17 | 10 | 3 | 8 | 3 | 1 |
| Example 5 | 100 | 17 | 25 | 3 | 8 | 3 | 1 |
| Example 6 | 100 | 17 | 17 | 2 | 8 | 3 | 1 |
| Example 7 | 100 | 17 | 17 | 5 | 8 | 3 | 1 |
| Example 8 | 100 | 17 | 17 | 3 | 5 | 3 | 1 |
| Example 9 | 100 | 17 | 17 | 3 | 10 | 3 | 1 |
| Example 10 | 100 | 17 | 17 | 3 | 8 | 2 | 1 |
| Example 11 | 100 | 17 | 17 | 3 | 8 | 5 | 1 |
| Example 12 | 100 | 17 | 17 | 3 | 8 | 3 | 0.5 |
| Example 13 | 100 | 17 | 17 | 3 | 8 | 3 | 2 |
| Comparative Example 1 | 100 | 5 | 17 | 3 | 8 | 3 | 1 |
| Comparative Example 2 | 100 | 17 | 30 | 3 | 8 | 3 | 1 |
| Comparative Example 3 | 100 | 17 | 17 | 1 | 8 | 3 | 1 |
| Comparative Example 4 | 100 | 17 | 17 | 3 | 3 | 3 | 1 |
| Comparative Example 5 | 100 | 17 | 17 | 3 | 8 | 10 | 1 |
| Comparative Example 6 | 100 | 17 | 17 | 3 | 8 | 3 | 0.2 |

Table 1 is a table showing the constituent components and contents of the Examples and Comparative Examples. Here, 50 kg of polyamide 6 was used and melt-kneaded in a twin extruder heated to 230° C. to 260° C. to prepare an intermediate in a chip shape, then the intermediate was dried at 85° C. for 6 hours by using a dehumidification type dryer, and test specimens of the Examples and Comparative Examples were prepared by using a screw-type injector heated to 230° C. to 260° C.

Results of the physical properties of specimens prepared by the preparation method were summarized in the following Table.

TABLE 2

| | | | | 23° C. Izod | | | |
|---|---|---|---|---|---|---|---|
| | Tensile | Flexural | Flexural | impact | −30° C. Izod | Heat deflection | |
| | strength | strength | modulus | strength | impact strength | temperature | Surface |
| Classification | (kg/cm²) | (kg/cm²) | (kg/cm²) | (kgcm/cm) | (kgcm/cm) | (0.45 MPa) | characteristics |
| Requirements (MS | 550 or more | 750 or more | 18,000 or | 30 or more | 15 or more | 160 or more | No singularities are |
| 211-54) | | | more | | | | visually observed |
| Example 1 | 580 | 770 | 20,000 | 50 | 17 | 170 | Good |
| Example 2 | 595 | 785 | 22,000 | 30 | 15 | 175 | Good |
| Example 3 | 550 | 750 | 18,000 | 80 | 18 | 160 | Good |
| Example 4 | 560 | 755 | 20,500 | 55 | 17 | 170 | Good |
| Example 5 | 560 | 760 | 18,500 | 40 | 15 | 165 | Good |
| Example 6 | 575 | 765 | 19,500 | 52 | 16 | 170 | Good |
| Example 7 | 580 | 775 | 20,200 | 51 | 17 | 170 | Good |
| Example 8 | 585 | 780 | 20,100 | 55 | 17 | 162 | Good |
| Example 9 | 590 | 775 | 21,000 | 40 | 15 | 172 | Good |
| Example 10 | 575 | 780 | 20,700 | 50 | 17 | 165 | Good |
| Example 11 | 585 | 780 | 20,500 | 40 | 16 | 175 | Good |
| Example 12 | 580 | 770 | 20,000 | 50 | 16 | 169 | Good |
| Example 13 | 585 | 765 | 20,300 | 50 | 17 | 170 | Good |
| Comparative | 585 | 790 | 21,000 | 35 | 10 | 175 | Good |
| Example 1 | | | | | | | |
| Comparative | 545 | 750 | 17,000 | 35 | 12 | 158 | Good |
| Example 2 | | | | | | | |
| Comparative | 540 | 780 | 20,500 | 32 | 9 | 161 | Peeled-off |
| Example 3 | | | | | | | |
| Comparative | 570 | 770 | 19,500 | 40 | 15 | 158 | Good |
| Example 4 | | | | | | | |
| Comparative | 585 | 790 | 21,500 | 35 | 13 | 172 | Flow mark |
| Example 5 | | | | | | | |
| Comparative | 580 | 770 | 19,500 | 48 | 16 | 169 | Discolored |
| Example 6 | | | | | | | |

Table 2 is a table showing results of physical properties tests performed by using specimens prepared based on the constituent components and contents of the Table 1.

The tensile strength in Table 2 was measured at a speed condition of 50 mm/min after the specimens were prepared in accordance with the American Society for Testing and Materials (ASTM) D638.

The flexural strength and flexural modulus were measured at a speed condition of 10 mm/min after the specimens were prepared in accordance with ASTM D790.

The Izod impact strength was measured at each 23° C. and −30° C. after a notch was formed on a specimen for preparation in accordance with ASTM D256.

The heat deflection temperature is a property for evaluating the heat resistance, and was measured under a condition of 0.45 MPa after the specimens were prepared in accordance with ASTM D648.

For the measurement of surface characteristics, the surface of a specimen with a size of 300 mm, 100 mm, and 3 mm in breath, length, and height, respectively was visually evaluated.

As a result of the tests, Examples 1 to 13 all satisfied the requirements of the results of physical properties tests. However, since Comparative Example 1 included a small amount of the ethylene-based copolymer, −30° C. Izod impact strength did not meet the requirements.

Since Comparative Example 2 included an excessive amount of the styrene-based copolymer, the flexural modulus, −30° C. Izod impact strength, and heat deflection temperature did not meet the requirements.

Since Comparative Example 3 included a small amount of the maleic anhydride grafted styrene, the tensile strength and −30° C. Izod impact strength did not meet the requirements and a peel-off phenomenon was found on the surface of the specimen.

Since Comparative Example 4 included an excessive amount of the imide-based copolymer, the heat deflection temperature did not meet the requirements.

Since Comparative Example 5 included an excessive amount of the nano minerals, −30° C. Izod impact strength did not meet the requirements, and a flow mark was found on the surface of the specimen.

Since Comparative Example 6 included a small amount of the phenolic heat-resistant material, the surface of the specimen was discolored.

Accordingly, when the composition does not satisfy the ranges of the =constituent components according to the present invention, it was confirmed that physical properties of the composition deteriorate and/or abnormalities occur on the surface.

As described above, the present invention has been described in relation to specific embodiments of the present invention, but this is only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A polyamide resin composition for a wheel cover comprising: a polyamide 6 resin, an ethylene-based copolymer, a styrene-based copolymer, a maleic anhydride grafted styrene, an imide-based copolymer, nano-minerals, and a phenolic heat-resistant material.

2. The polyamide resin composition for a wheel cover of claim 1, comprising about 10 to 25 parts by weight of the ethylene-based copolymer, about 10 to 25 parts by weight of the styrene-based copolymer, about 2 to 5 parts by weight of the maleic anhydride grafted styrene, about 5 to 10 parts by weight of the imide-based copolymer, about 2 to 5 parts by weight of nano minerals, and about 0.5 to 2 parts by weight of the phenolic heat-resistant material, based on 100 parts by weight of the polyamide 6 resin.

3. The polyamide resin composition for a wheel cover of claim 1, wherein the polyamide 6 resin has a relative viscosity of about 2.7 to 3.5.

4. The polyamide resin composition for a wheel cover of claim 1, wherein the ethylene-based copolymer is a random block copolymer of ethylene and octene, in which the maleic anhydride is grafted.

5. The polyamide resin composition for a wheel cover of claim 1, wherein styrene in the styrene-based copolymer is present in an amount of about 80 to 90 parts by weight based on 100 parts by weight of the styrene-based copolymer.

6. The polyamide resin composition for a wheel cover of claim 1, wherein grafted maleic anhydride in the maleic anhydride grafted styrene is present in an amount of about 5 to 15 parts by weight based on 100 parts by weight of the styrene.

7. The polyamide resin composition for a wheel cover of claim 1, wherein the imide-based copolymer is a polyamide imide in which amide and imide are bonded to each other.

8. The polyamide resin composition for a wheel cover of claim 1, wherein the nano minerals are a clay having an average particle size from about 1 to 100 nm.

9. The polyamide resin composition for a wheel cover of claim 1, wherein the heat-resistant material is N,N′-hexamethylenebis(3,5-di-tert-butyl-4-hydroxyhydrocinnamide).
